(19) United States
(12) Patent Application Publication
(10) Pub. No.: US 2009/0205257 A1
(43) Pub. Date: Aug. 20, 2009

(54) RESISTANT TILT-IN WINDOWS

(76) Inventors: Kurt Winner, Waipahu, HI (US); Clint Tirpak, Waipahu, HI (US)

Correspondence Address: OSTROLENK FABER GERB & SOFFEN, 1180 AVENUE OF THE AMERICAS, NEW YORK, NY, 100368403, US

(21) Appl. No.: 12/034,030

(22) Filed: Feb. 20, 2008

(51) Int. Cl. E05D 15/22

(52) U.S. Cl. 49/161; 49/181; 49/506

(57) ABSTRACT

A tilt in window with sashes movably mounted to the interior of the frame and inwardly pivotable. Each of the sashes is held within jamb channels by capture legs which overlap a portion of the interior side of the sashes to restrain the sashes from inward movement, when the window is normally closed. The sashes are movable within the jamb channels for a distance to permit sashes to be removed from being held by the retaining members. With such removal the sashes are able to be inwardly pivoted. In one embodiment, a bottom outwardly facing sill is sloped downward to prevent water accumulation with the sill being integrated with sloping jamb sections, in continuity with the sill. The frame has retention elements for snap in parallel placement of separate jamb members having channels with the capture legs for holding the sashes and channels for the counterbalance weights or springs.

### FIELD OF THE INVENTION

This invention relates to tilt-in type hung window assemblies in which the frame and the sashes of each of the window units are constructed of extrusions, typically of rigid plastic or aluminum.

### BACKGROUND OF THE INVENTION

A hung window system typically consists of a frame, normally a vertical rectangle containing one or two vertically sliding sashes or sash units, one mounted over the other and one offset from the other (in an inner and outer configuration). Each sash slides vertically in its own track system comprised of opposing parallel channels in a jamb section. Each sash is counterbalanced either with the old weight and pulley system or a more modern metal spring system. Two operating sashes are referred to as a double hung window, however, if one sash is fixed in place it is called a single hung window.

The most popular version of the hung (whether double hung or single hung) window contains a tilt-in feature which allows the sash(es) to be tilted in for cleaning both sides of the glass from inside the room.

The tilt in feature means that there is no captive channel or similar containment device to resist inward sash motion. This results in a relatively weak assembly when subjected to inwardly directed wind pressures, with possible window damage. Tilt in convenience thus comes at a substantial performance sacrifice.

The conventional tilt in sash is captured only at its four corners. The two top corners contain a finger operated latch mechanism that engages the perimeter frame. When the latches are depressed, they disengage the perimeter frame and allow the sash to be tilted inward. The two lower corners of the sashes contain a pivot bar device that engages vertically sliding balance shoes in the frame balance channels. These balance shoes also permit rotation of the pivot bar which accommodates the tilting action of the sash.

U.S. Pat. No. 4,640,048, by the applicant herein, describes a lower window unit, known as an inner sash, that is vertically slidable and is also inwardly tiltable about a horizontal axis located at the lower rail of the sash as a single hung (SH) configuration.

A typical tilt in double hung (DH) window is described in applicant's U.S. Pat. No. 5,014,466. Although specific improvements are shown in the patent, the sashes have no inherent capture device, to resist inward wind pressure or other forces, other than the upper releasable latches and a metal spring device, which provides some interference holding. The windows shown in these patents are generally representative of the state of the art for such windows and the disclosure thereof in such patents is incorporated herein by reference thereto.

In window assemblies of both SH and DH tilt-in configurations, because of the inherent design to enable the tilt-in cleaning function of both SH and DH tiltable windows, significant support is removed from the window interiors making them weaker and unable to restrain or resist strong external forces such as high winds. Relatively weak releasable holding elements serve to hold the windows upright in a closed position and this results in a weakly force resistant assembly when the window is subjected to the inwardly directed wind pressures.

The vast majority of single hung (SH) and double hung (DH) windows produced in the United States are of the tilt-in design. Most of them have an outer downwardly sloped sill, of which 50% use a sloped sill filler fitted on a flat sill section to accomplish the sloped sill effect. The remaining 50% of hung windows actually use an integral original sloped sill, but attach it directly to a jamb extrusion that contains the balance channels. The outward down slope in all forms is introduced to prevent rain water from accumulating at or entering around the sashes by means of a simple gravity run-off. However, both alternative structures of the sloping sills have disadvantages. The alternative of using sill fillers with a separate sloping sill attachment which is simple to utilize, provides windows which are susceptible to water penetration (leakage) between the sill filler and window frame base.

With the other alternative of providing an integral sloping sill, the different jamb and sill profiles are extremely difficult to weld or otherwise integrate, because they have few common walls. Thus, although this latter system works and sounds like a simple solution it involves a very expensive method of sawing the compound corner angles and also involves complicated welding fixtures which often cost hundreds of thousands of dollars.

### SUMMARY OF THE DISCLOSURE

It is accordingly an object of the present disclosure to provide a window assembly having a tilt-in window function but which has significantly enhanced resistance to external inwardly directed forces but without significant interference with the tilt-in function.

It is a further object of the present disclosure to provide such feature for both single hung and double hung windows having tilt-in configurations.

It is another object of the present disclosure to provide a window assembly with a single unitary sloped sill and frame to minimize any water retention with snap in jamb insertions having customized window capture elements to provide the enhanced strength resistance.

Another object is to provide manufacturers a low cost method of tooling up a factory to produce a superior product.

These and other objects, features and advantages of the present disclosure will become more evident from the following discussion and drawings in which:

### SHORT DESCRIPTION OF THE DRAWINGS

FIGS. 1a and 1b are tilt in single and double hung windows respectively of the prior art shown in a sash tilted-in position;

FIG. 2 is an inside normal closed view of a tilt-in double hung window of the present invention,

FIGS. 3a and 3b are schematic side cross section views of single hung and double hung windows respectively of the present invention shown in closed and (in dotted lines) tilt-in positions;

FIG. 4 is a perspective view of a snap in jamb extrusion of the present invention,

FIG. 5 is a side section view of the double hung window taken along line 5-5 of FIG. 2;

FIG. 6 is a partial top sectioned view of the double hung window of FIG. 2 taken along line 6-6, showing the snap in jamb and frame configuration, and

FIG. 7 is a cross section top view of balance shoe weight assembly and one pivot bar tie in and for the pivoted tilt-in function.

### DETAILED DESCRIPTION OF THE DISCLOSURE

Generally the present disclosure comprises a tilt in window assembly either of single hung or double hung configuration. The tilt-in widow or window assembly comprises a frame defining a rectangle, of parallel side jambs, a bottom sill and a top header. For water-tight construction, the parallel sides at the bottom sill are preferably integrated. The window further comprises a pair of sash units which are each (or one with a single hung window) movably mounted to the interior of the frame within opposed pairs of parallel jambs. The movable sash unit(s) move up and down within the parallel jambs toward the bottom sill and the top header respectively. At least one sash unit is inwardly pivotable by being connected to the pair of parallel jambs with a pair of pivoting elements preferably at the lower end corners of the sash unit. The sash unit is held in an upright position, within the parallel jambs by at least one releasable lock. In accordance with the present invention, the sash is further held within the parallel jambs by retention members preferably in the form of overlapping capture legs which extend from each of the parallel jambs toward each other to overlap at least a portion of the interior side of the sash. These serve to restrain the sash, when the window is normally closed, from inward pivoting and they provide structural reinforcement against inwardly directed forces such as high winds. The maximum height of the overlapping capture leg members is the height of the sash, less a height necessary to permit sash movement to enable the sash to entirely clear the leg and permit room for inward tilt-in pivoting. In an embodiment of a single hung window, the leg members may extend to cover and reinforce a major portion of the height of the sash. With a double hung window, each sash is moved to clear adjacent leg members as well as not being interfered with by the leg members of the other sash in addition to providing room for pivoting of two sashes. As a result, particularly for a symmetrical appearance, maximum capture leg member extension is less. Minimum leg member height is a function of the degree of reinforcement desired.

The extent of the inward extension of each leg is dependent on the strength of the leg material and the desired wind resistance but generally an overlap, as with non-tiltable windows of an outer jamb channel wall, is generally sufficient. In a preferred embodiment of the present invention the parallel jambs are initially configured with full parallel channels for retention of sashes, as with non tilt-in windows, with portions of the channels being removed to permit the requisite sash clearance and pivot for tilt-in function. Tilt-in windows can accordingly be customized for different sizes by means of channel portion removal devices such as by using inexpensive table saws and materials which are readily cut such as aluminum and PVC commonly used in window constructions. For single hung windows only a portion of the innermost jamb wall need be removed to permit the single sash to pivot therethrough. With double hung windows, both inner and outer walls of the inner jamb need to have portions removed as well as the inner wall of the outer jamb in order to further permit the outer sash to extend inwardly.

In a particularly preferred embodiment of the present invention, the jamb elements with sash retaining channels, as well as balance channels are configured as separable longitudinal elements which are adapted with cooperative elements to be fixedly placed with a snap in connection with the inner side walls of the window frame. In such embodiment the jamb elements are easily customized prior to placement. In addition, with such embodiment, the frame can be constructed with a unitary slope sill with a configuration integrally carried around the perimeter of the frame with the jamb elements being adapted to be appropriately slope based configured with cooperative snap in elements. This is the reverse of the common practice of providing built in jamb elements and using sill fill in elements to connect a separable sill part. In addition to providing the advantages of enhanced and economical customization, the unitary sloped sill effectively eliminates the water retention which separable slope sill units are susceptible to, but without the expense normally entailed in providing single unit rain and water resistant sills.

### DETAILED DESCRIPTION OF THE DRAWINGS AND THE PREFERRED EMBODIMENTS

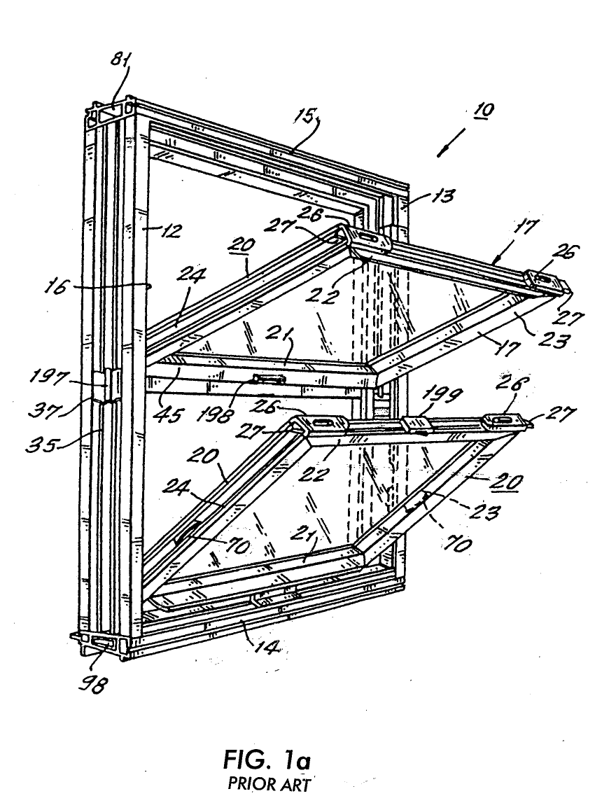

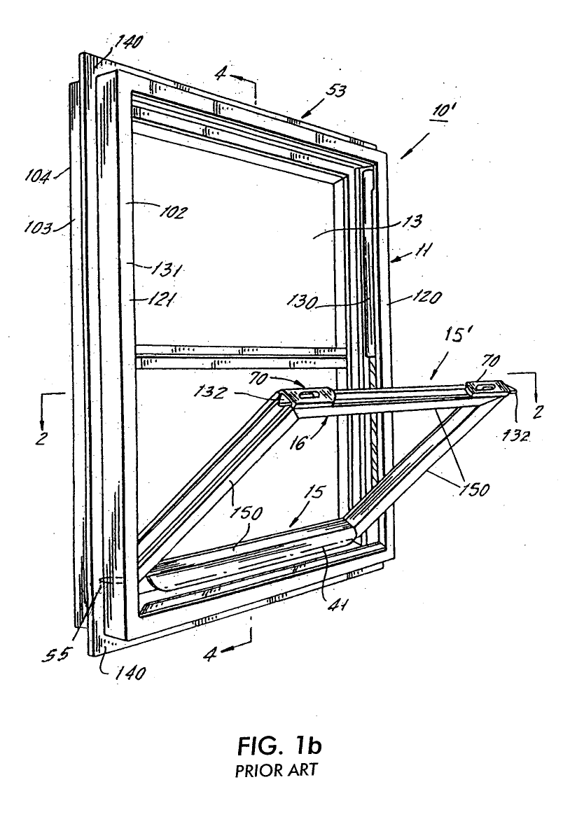

With specific reference to the drawings, FIGS. 1a and 1b depict typical prior art double and single hung window respectively 10′ and 10 with a tilt in configuration. With the single movable sash configuration shown in FIG. 1b sash 15′ is shown as pivoting inwardly. In the double hung window configuration of FIG. 1a, separate sashes 17 and 21 are shown as swiveling inwardly at their separate bases. The rectangular window configuration in FIG. 1a is comprised of outwardly sloping sill 14 and head 15. Channel locking elements 26 (elements 132 in the single hung window of FIG. 1b) hold the respective sashes in an upright position and such locking elements and metal interference springs 70 are all that hold the sashes 17 and 21 from being pivotally blown inwardly with external forces such as high winds. The inner sash is typically the lower sash and the outer sash is typically the upper sash.

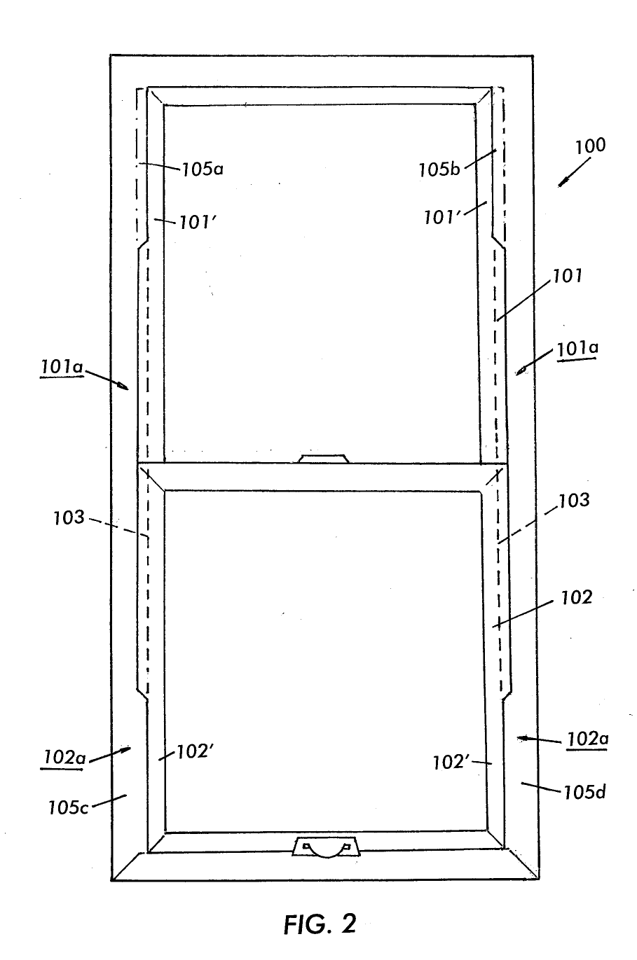

The double hung window embodiment 100 of the present invention in FIG. 2 is shown from the interior, in the fully closed position. Upper and lower sashes 101 and 102 (also inner and outer sashes) are shown as being further held in position by “capture leg” elements 105a-b and 105c-d respectively. The capture leg elements are extending lip elements which overlap and retain sections of the sash frames 101′ and 102′ and are specifically sized cutout remainders of wall elements 101a and 102a of the side jamb channels. The cutouts 103 are shown in phantom by dotted lines.

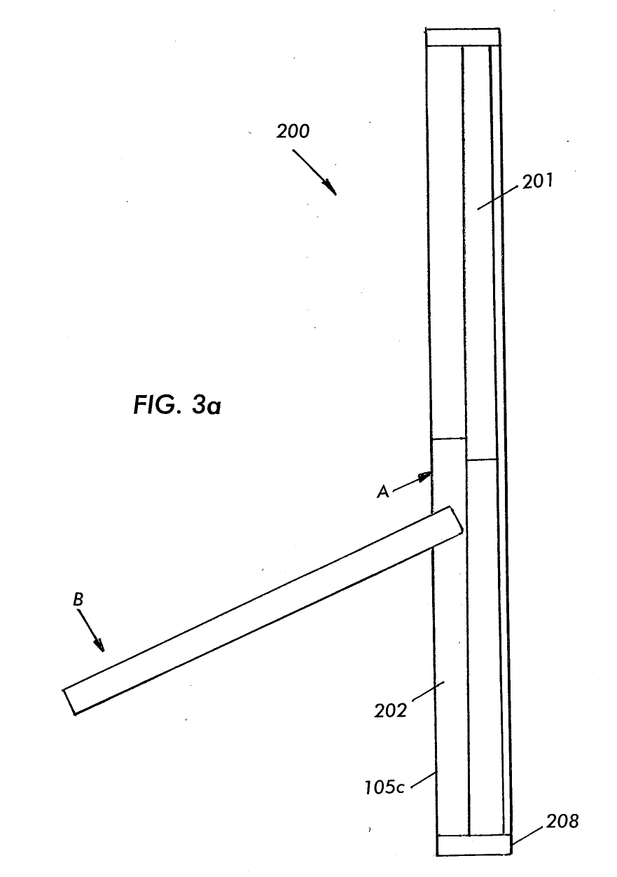

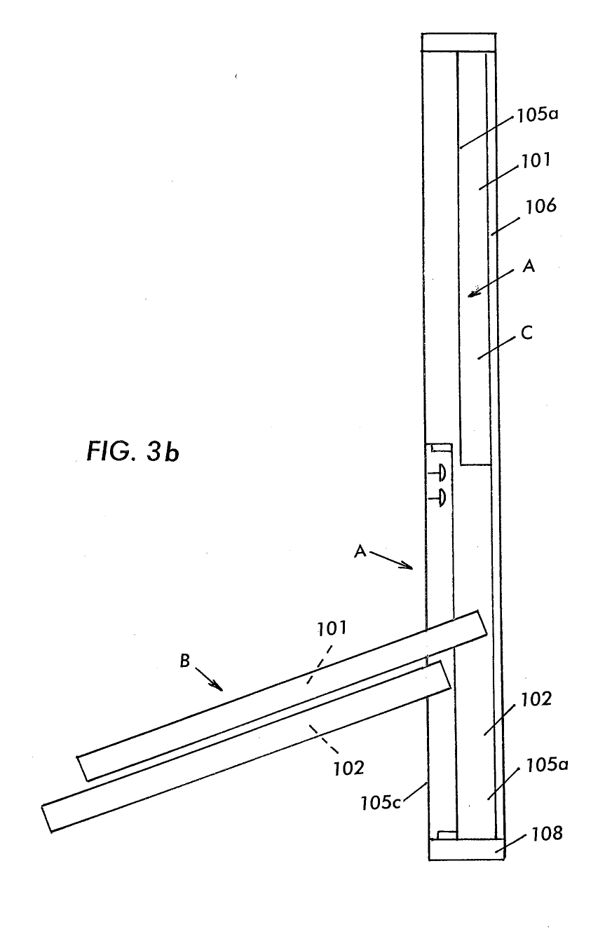

As is more clearly seen from the schematic side view DH window of FIG. 3b, lower sash 102 (in closed position A) is retained against inward movement within capture leg elements 105c. Upper sash 101 (in closed position A) is retained against inward movement by capture leg element 105a. The outer wall channel 106 is uncut and completely abuts upper sash 101 without separate capture legs (channel wall 106 provides no support against inwardly directed forces). Cutout distance C between the ends of the rear lower capture legs and upper capture leg is sized to at least permit upper sash 101 to be lowered to clear the bottom of the capture leg 105a (as shown) but without abutting the lower capture leg 105c and to permit lower sash 102 to pivot about pivot shoe elements 107 which are securely fixed to the sash and movably retained within counterbalance force channels in the jamb. Though lower sash 101 is not similarly restricted in raising height by an upper capture leg element and interference therewith, raising height of the lower sash is however dictated by permitting clearance for the upper sash to extend inwardly without interference with the lower sash.

The cutout distance C may also be sized for a symmetrical appearance (though this is not a requirement and is absent in single hung windows) and to permit the upper sash 101 to be lowered to clear capture leg 105c without interfering with lower capture leg 105c or with pivoted lower sash 102. The inwardly tilted sashes 101 and 102 are shown in position B in dotted line in FIG. 3b.

The schematic side view of the single hung window 200 embodiment shown in FIG. 3a, with a movable lower sash 202 and a fixed upper sash 201 has only front capture legs 205c for permitting tilting of the lower sash. Accordingly, the front capture legs 205c can extend upwardly to nearly the full height of the sash less room to permit the pivot and tilt in position B′ as shown in dotted line.

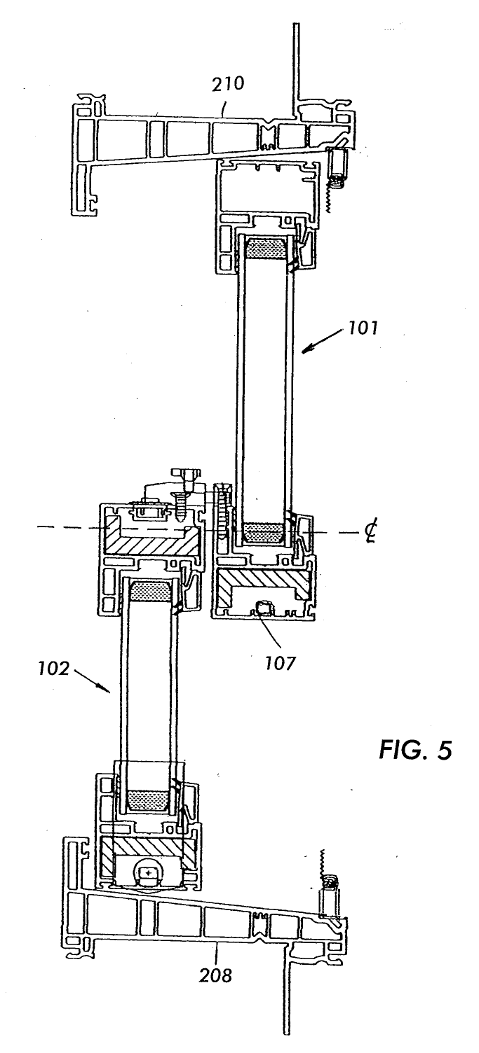

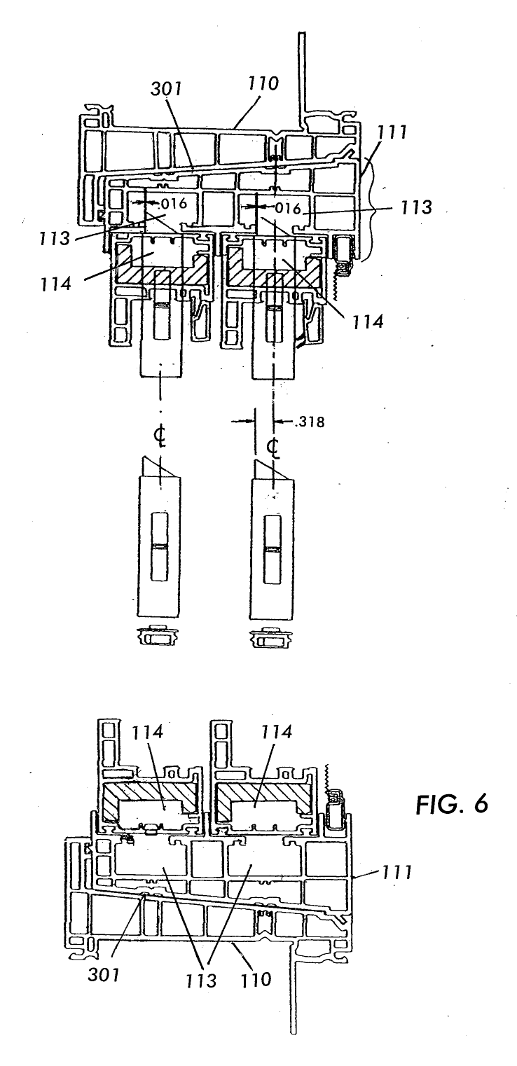

In FIGS. 1b, 3a and 3b, the window frames are shown with sills 98, 208 and 108 respectively which are outwardly downwardly sloped to prevent water accumulation. In the past, as described above, window frames have been made in rectangular form with the jamb channels extrusions carried around the entire frame for facilitated formation. As shown in prior art FIG. 1b, a sloped sill member with an integral fill section 98 is adapted to and is fitted within the base of frame. This may result in water accumulation problems inherent with separated multiple piece constructions or in construction problems. As shown in FIGS. 3a, 3b and FIG. 5, the respective sills 108 and 208 are of single unitary construction which is carried around the full frame as seen with the jamb section 110 of FIG. 6. FIG. 6 depicts the sloping jamb base 112 and the snap in jamb sections 111 interfitted to provide the parallel level jamb channels (113 for the counterbalance and 114 fore the sash channels).

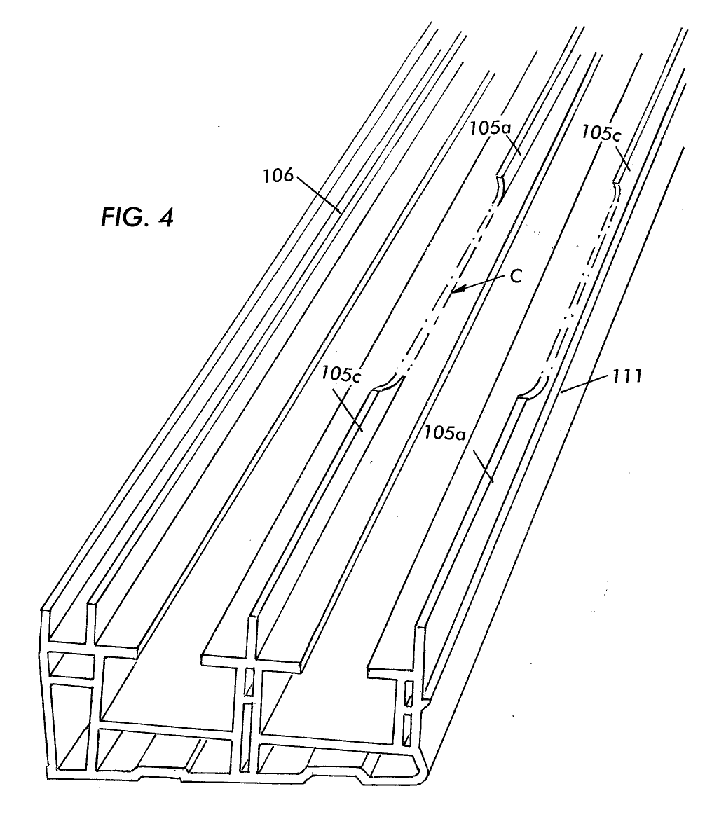

FIG. 4 depicts a PVC jamb extrusion 300 which is fitted into the sloping retaining members of the jamb channels shown in FIG. 6 for a DH window as shown in FIGS. 2 and 3b. The jamb extrusion 111 has a sloped profile at 301, which is interfitted with sloping frame base 110 as described. Cutouts 103 (shown in dotted line) are removed from the channels as shown with outer wall remaining intact to provide capture legs 105a and 105c. It is noted that the jamb extrusion is made symmetrical for placement in either of the jambs and accordingly there are both upper lower capture legs for the lower sash though only a lower capture leg is required, as seen from FIG. 3b. Separate, non-symmetrical configurations are however also within the scope of the present invention.

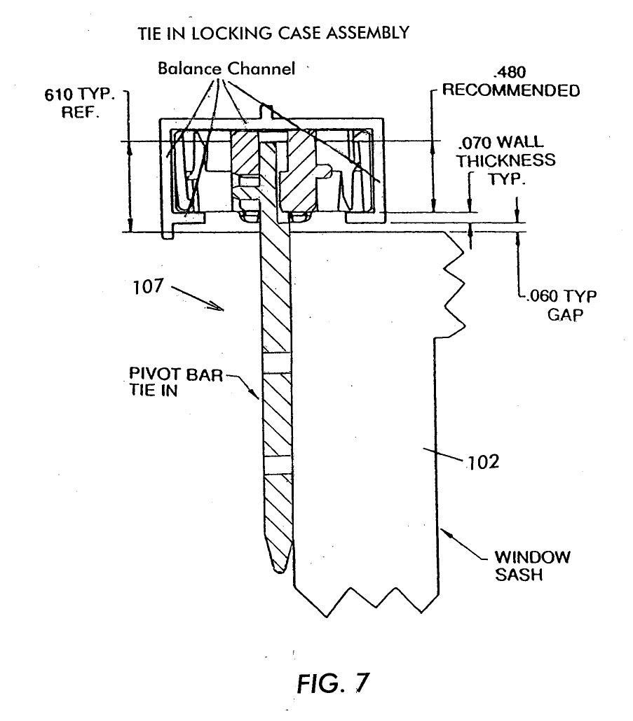

In accordance with an embodiment of the present invention as depicted in FIG. 5, pivot bars 107 are shown for sashes 101 and 102 at the respective bases with an expanded top view of the pivot bar 107 shown in FIG. 7. Pivot bar tie-in 107 is inserted into the base of the respective sashes (one bar for each lower corner of each sash). The mechanism for the pivot bar is movably contained within the balance channel of the jamb extrusion. The bar, as described in U.S. Pat. No. 5,353,548, is movable between a locked tilted position and an unlocked sash vertical or closed position. The contents of said U.S. Pat. No. 5,353,548 are incorporated by reference herein.

The aforementioned snap-in jamb extrusions also solve the water leakage problem of a snap-in sill member and also eliminates the need for expensive compound notching machines and compound shaped welding plates that are necessary when directly joining dissimilar extrusion shapes, i.e., a sloping sill to a jamb shape. The savings in special cutting and welding machines are on the order of several hundred thousand dollars, plus solving the inherent problems associates with added complexity.

For example, because the cost comparison may be roughly $300,000 tooling for the compound notched frame (the direction the industry is heading), versus the simple tooling that could be utilized for the purposes of constructing the window assembly of the present invention, which is on the order of about $30,000, total. This amounts to a cost savings on the order of one-tenth of the industry set standard.

It is understood that the above detailed description and drawings are exemplary of the present invention and that changes in structure and components may be made without departing from the scope of the present invention as defined in the following claims.

What is claimed is:

1. A tilt in window assembly comprising:
a frame defining a rectangle having parallel side jambs;
a bottom sill and a top header;
a pair of sash units wherein at least one of the sash units is movably mounted to the interior of the frame within opposed pairs of parallel jamb channels and each sash unit comprises a respective window;
wherein each of the movably mounted sash units is configured to move up and down between the parallel jambs, toward the bottom sill and the top header respectively, with the movably mounted sash units being normally held in an upright position and being capable of being inwardly pivoted;
wherein each of the movable sash units is held within opposed pairs of parallel jamb channels by retaining members which overlap at least a portion of the interior side of the movable sash units to restrain the sash from inward movement, when the window is normally closed; and
wherein the movable sash units are movable within the opposed parallel jamb channels for a distance which causes the movable sash units to be removed from being held by the retaining members, such that the window assembly is configured to permit the movable sash units to be pivoted inwardly.

2. The tilt in window assembly of claim 1, wherein the retaining members are integral with the parallel jambs.

3. The tilt in window assembly of claim 1, wherein the window assembly is a single hung window assembly with the window having one movable sash unit and one non movable sash unit.

4. The tilt in window assembly of claim 3, wherein the movable sash unit is movably contained within opposed channels of the parallel jambs, the channels each having inwardly and outwardly facing channel walls with opposing sections of the inwardly facing walls of each of the parallel channels having been removed along the length of the jamb, and opposing sections remaining, with the remaining opposing sections of the inwardly facing wall being of sufficient length to comprise the retaining members, and with the removed sections being of sufficient length along a length of the parallel jambs to permit the movable sash unit to be moved from being retained in the closed position to a position with the movable sash unit being free to clear the remaining opposed sections and to permit the movable sash unit to be inwardly pivoted.

5. The tilt in window assembly of claim 4, wherein the window is a double hung window with the window having two movable sash units comprising inner and outer sash units.

6. The tilt in window assembly of claim 5, wherein each movable sash unit is movably contained within opposed channels of the parallel jambs, the channels each having inwardly and outwardly facing channel walls with opposing sections of the inwardly facing walls of each of the parallel channels having been removed along the length of the jamb, and opposing sections remaining, and opposing sections of the outwardly facing walls of the channels in which the inner sash unit is movably contained, with the remaining opposing sections of the inwardly facing walls being of sufficient length to comprise the retaining members, and with the removed sections of the inwardly and outwardly facing walls being of sufficient length along a length of the parallel jambs to permit the inner and outer movable sash units to be moved from being retained in the closed position to a position with each of the movable sash units being free to clear all of the remaining opposed sections and to permit the movable sash units to be inwardly pivoted.

7. The tilt in window assembly of claim 1, wherein the bottom outwardly facing sill is sloped downward to prevent water accumulation and wherein the sill is integral with the frame, with the frame sloping in continuity with the sill and wherein the frame comprises retention elements for snap in parallel placement of jamb members with jamb channels.

8. The tilt in window assembly of claim 7, wherein the jamb members and jamb channels are symmetrical around a central cross section whereby the jamb members with jamb channels can be interchangeably used for each of the parallel sides.

9. A method of fabricating a tilt in window assembly, comprising the steps of:
forming a frame defining a rectangle having parallel side jambs, without using any compound notching machines or compound shaped welding plates;
forming a bottom sill and a top header;
forming a pair of sash units wherein at least one of the sash units is movably mounted to the interior of the frame within opposed pairs of parallel jamb channels and each sash unit comprises a respective window;
wherein each of the movably mounted sash units is configured to move up and down between the parallel jambs, toward the bottom sill and the top header respectively, with the movably mounted sash units being normally held in an upright position and being capable of being inwardly pivoted;
wherein each of the movable sash units is held within opposed pairs of parallel jamb channels by retaining members which overlap at least a portion of the interior side of the movable sash units to restrain the sash from inward movement, when the window is normally closed; and
wherein the movable sash units are movable within the opposed parallel jamb channels for a distance which causes the movable sash units to be removed from being held by the retaining members, such that the window assembly is configured to permit the movable sash units to be pivoted inwardly, and
wherein the forming of said bottom sill, top header, sash units, parallel jamb channels and retaining members are all fabricated without the use of either any compound notching machines or compound shaped welding plates.
